(19) United States
(12) Patent Application Publication
(10) Pub. No.: US 2023/0209462 A1
(43) Pub. Date: Jun. 29, 2023

(54) USER EQUIPMENT AND METHOD FOR POWER SAVING

(71) Applicant: FG Innovation Company Limited, Tuen Mun (HK)

(72) Inventors: HSIN-HSI TSAI, Taipei (TW); MEI-JU SHIH, Taipei (TW); HUNG-CHEN CHEN, Taipei (TW)

(21) Appl. No.: 17/927,103

(22) PCT Filed: May 27, 2021
(86) PCT No.: PCT/CN2021/096197

§ 371 Date: Nov. 22, 2022

Related U.S. Application Data
(60) Provisional application No. 63/030,225, filed on May 26, 2020.

(51) Int. Cl. H04W 52/02

(52) U.S. Cl. CPC H04W 52/0216

(57) ABSTRACT

A user equipment (UE) and a method for performing a power saving operation are provided. The method includes receiving a radio resource control (RRC) configuration from a base station (BS), the RRC configuration configuring a set of one or more time durations; beginning monitoring a physical downlink control channel (PDCCH) on a plurality of PDCCH monitoring occasions; receiving an indicator on the PDCCH from the BS via downlink control information (DCI), the indicator indicating a first time duration among the set of one or more time durations; and skipping monitoring the PDCCH on one or more of the plurality of PDCCH monitoring occasions within the first time duration after receiving the indicator.

### CROSS-REFERENCE TO RELATED APPLICATIONS

The application is the National Stage Application of International Patent Application Serial No. PCT/CN2021/096197, filed on May 27, 2021, which claims the benefit of and priority to U.S. Provisional Patent Application Ser. No. 63/030,225, filed on May 26, 2020. The contents of all of the above-mentioned applications are hereby incorporated herein fully by reference for all purposes.

### FIELD

The present disclosure is related to wireless communication and, more specifically, to a power saving operation in cellular wireless communication networks.

### BACKGROUND

Various efforts have been made to improve different aspects of wireless communication for cellular wireless communication systems, such as fifth-generation (5G) New Radio (NR), by improving data rate, latency, reliability, and mobility. The 5G NR system is designed to provide flexibility and configurability to optimize the network services and types, accommodating various use cases such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a power saving operation in cellular wireless communication networks.

According to a first aspect of the present disclosure, a method performed by a UE for a power saving operation is provided. The method includes receiving a radio resource control (RRC) configuration from a base station (BS), the RRC configuration configuring a set of one or more time durations; beginning monitoring a physical downlink control channel (PDCCH) on a plurality of PDCCH monitoring occasions; receiving an indicator on the PDCCH from the BS via downlink control information (DCI), the indicator indicating a first time duration among the set of one or more time durations; and skipping monitoring the PDCCH on one or more of the plurality of PDCCH monitoring occasions within the first time duration after receiving the indicator.

In an implementation of the first aspect, the method further includes resuming monitoring the PDCCH on the plurality of PDCCH monitoring occasions after the first time duration is over.

In another implementation of the first aspect, the first time duration is one of a number of the plurality of PDCCH monitoring occasions, a number of time units, a number of paging occasions (POs), or a number of discontinuous reception (DRX) cycles.

In another implementation of the first aspect, the time units include one of slots, symbols, hyper system frames, system frames, radio frames, seconds, or milliseconds.

In another implementation of the first aspect, the first time duration is determined based on a timer configured by the RRC configuration.

In another implementation of the first aspect, the plurality of PDCCH monitoring occasions are determined according to a search space configured by the BS.

In another implementation of the first aspect, the DCI includes a DCI format 1_0.

In another implementation of the first aspect, the DCI further indicates a UE group.

In another implementation of the first aspect, the UE group is formed based on at least one of a UE identifier (ID) or UE assistance information.

In another implementation of the first aspect, the UE belongs to the UE group.

According to a second aspect of the present disclosure, a UE for performing a power saving operation is provided. The UE includes at least one processor and at least one memory coupled to the at least one processor, the at least one memory storing one or more computer-executable instructions that, when executed by the at least one processor, cause the UE to perform operations including receiving an RRC configuration from a BS, the RRC configuration configuring a set of one or more time durations; beginning monitoring a PDCCH on a plurality of PDCCH monitoring occasions; receiving an indicator on the PDCCH from the BS via DCI, the indicator indicating a first time duration among the set of one or more time durations; and skipping monitoring the PDCCH on one or more of the plurality of PDCCH monitoring occasions within the first time duration after receiving the indicator.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 illustrates a DRX mechanism for paging monitoring according to an example implementation of the present disclosure.

FIG. 2 illustrates a paging process according to an example implementation of the present disclosure.

FIG. 3 illustrates a system information (SI) acquisition procedure according to an example implementation of the present disclosure.

FIG. 4 illustrates a method for indicating the information for power saving via an RRC release message according to an example implementation of the present disclosure.

FIG. 5 illustrates a process of skipping monitoring multiple PDCCH monitoring occasions and/or paging occasions according to an example implementation of the present disclosure.

FIG. 6 illustrates a process of skipping monitoring PDCCH monitoring occasions and/or POs for a time duration according to an example implementation of the present disclosure.

FIG. 7 illustrates a process of skipping monitoring PDCCH monitoring occasions and/or POs based on a timer according to an example implementation of the present disclosure.

FIG. 8 illustrates a method performed by a UE for a power saving operation according to an example implementation of the present disclosure.

FIG. 9 is a block diagram illustrating a node for wireless communication according to an example implementation of the present disclosure.

### DESCRIPTION

Abbreviations used in this disclosure include:

| Abbreviation | Full name |
|---|---|
| 5GC | 5G Core |
| 5G-S-TMSI | 5G S-Temporary Mobile Management Identifier |
| AS | Access Stratum |
| BA | Bandwidth Adaptation |
| BCCH | Broadcast Control Channel |
| BCH | Broadcast Channel |
| BS | Base Station |
| BWP | Bandwidth Part |
| CMAS | Commercial Mobile Alert Service |
| CN | Core Network |
| CORESET | Control Resource Set |
| CRC | Cyclic Redundancy Check |
| C-RNTI | Cell Radio Network Temporary Identifier |
| CS-RNTI | Configured Scheduling Radio Network Temporary |
| | Identifier |
| CSI-RS | Channel State Information Reference Signal |
| DCI | Downlink Control Information |
| DL | Downlink |
| DL-SCH | Downlink Shared Channel |
| DRX | Discontinuous Reception |
| eMBB | Enhanced Mobile Broadband |
| eMTC | Enhanced Machine Type Communication |
| EPC | Evolved Packet Core |
| ETWS | Earthquake and Tsunami Warning System |
| EUTRA | Evolved Universal Terrestrial Radio Access |
| FR | Frequency Range |
| HARQ | Hybrid Automatic Repeat Request |
| ID | Identifier |
| IE | Information Element |
| I-RNTI | Inactive RNTI |
| LTE | Long Term Evolution |
| MAC | Medium Access Control |
| MCG | Master Cell Group |
| MIB | Master Information Block |
| MIMO | Multiple Input Multiple Output |
| MME | Mobility Management Entity |
| MO | (PDCCH) Monitoring Occasion |
| MSG | Message |
| MTC | Machine-Type Communications |
| NAS | Non-Access Stratum |
| NB-IoT | Narrowband Internet of Things |
| NG-RAN | Next-Generation Radio Access Network |
| NR | New Radio |
| NR-U | New Radio Unlicensed |
| NW | Network |
| OFDM | Orthogonal Frequency Division Multiplexing |
| PCell | Primary Cell |
| PCCH | Paging Control Channel |
| PDCCH | Physical Downlink Control Channel |
| PDCP | Packet Data Convergence Protocol |
| PDSCH | Physical Downlink Shared Channel |
| PDU | Protocol Data Unit |
| PF | Paging Frame |
| PHY | Physical |
| PO | Paging Occasion or PDCCH monitoring occasion |
| PRACH | Physical Random Access Channel |
| P-RNTI | Paging RNTI |
| PSCell | Primary Secondary Cell |
| PS-RNTI | Power Saving RNTI |
| PUCCH | Physical Uplink Control Channel |
| PUSCH | Physical Uplink Shared Channel |
| PWS | Public Warning System |
| QoS | Quality of Service |
| RA | Random Access |
| RACH | Random Access Channel |
| RAN | Radio Access Network |
| RAT | Radio Access Technology |
| Rel | Release |
| RLC | Radio Link Control |
| RMSI | Remaining Minimum System Information |
| RNA | RAN-based Notification Area |
| RNTI | Radio Network Temporary Identifier |
| RRC | Radio Resource Control |
| RRM | Radio Resource Management |
| RSRP | Reference Signal Received Power |
| RSRQ | Reference Signal Received Quality |
| RSSI | Received Signal Strength Indication |
| RTT | Round Trip Time |
| SA | Stand Alone |
| SAP | Service Access Point |
| SCell | Secondary Cell |
| SCG | Secondary Cell Group |
| SDAP | Service Data Adaptation Protocol |
| SFN | System Frame Number |
| SI | System Information |
| SIB | System Information Block |
| SINR | Signal to Interference plus Noise Ratio |
| S-NSSAI | Single Network Slice Selection Assistance Information |
| SRB | Signaling Radio Bearer |
| SRS | Sounding Reference Signal |
| SSB | Synchronization Signal Block |
| S-TMSI | SAE-Temporary Mobile Subscriber Identity |
| TB | Transport Block |
| TM | Transparent Mode |
| TRP | Transmission/Reception Point |
| TS | Technical Specification |
| UE | User Equipment |
| UL | Uplink |
| URLLC | Ultra-Reliable Low-Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected, whether directly or indirectly via intervening components, and is not necessarily limited to physical connections. The term “comprising” means “including, but not necessarily limited to” and specifically indicates open-ended inclusion or membership in the so-disclosed combination, group, series, or equivalent. The expression “at least one of A, B and C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer-executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS can communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (Pscell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology such as adaptive sub-carrier spacing, channel bandwidth, and Cyclic Prefix (CP) may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following sentences, paragraphs, (sub)-bullets, points, actions, behaviors, terms, alternatives, aspects, examples, or claims described in the following invention(s) may be combined logically, reasonably, and properly to form a specific method.

Any sentence, paragraph, (sub)-bullet, point, action, behaviors, terms, alternatives, aspects, examples, or claims described in the following disclosure may be implemented independently and separately to form a specific method.

Dependency, such as “based on”, “more specifically”, “preferably”, “in one embodiment”, “in one alternative”, “in one example”, “in one aspect”, “in one implementation”, etc., in the present disclosure is just one possible example which would not restrict the specific method.

Examples of some selected terms are provided as follows.

User Equipment (UE): The UE may be referred to as a PHY/MAC/RLC/PDCP/SDAP entity. The PHY/MAC/RLC/PDCP/SDAP entity may be referred to as the UE.

Network (NW): The NW may be a network node, a TRP, a cell (e.g., SpCell, PCell, PSCell, and/or SCell), an eNB, a gNB, and/or a base station.

Serving Cell: A PCell, a PSCell, or an SCell. The serving cell may be an activated or a deactivated serving cell.

Special Cell (SpCell): For Dual Connectivity operation the term Special Cell refers to the PCell of the MCG or the PSCell of the SCG depending on if the MAC entity is associated with the MCG or the SCG, respectively. Otherwise, the term Special Cell refers to the PCell. A Special Cell supports PUCCH transmission and contention-based Random Access, and is always activated.

Component Carrier (CC): The CC may be PCell, PSCell, and/or SCell.

Network (NW), Radio Access Network (RAN), cell, camped cell, serving cell, base station, gNB, eNB, and ng-eNB may be used interchangeably in the present disclosure. In some implementations, some of these items may refer to the same network entity.

The disclosed mechanism may be applied to any RAT. The RAT may be (but is not limited to) NR, NR-U, LTE, E-UTRA connected to 5GC, LTE connected to 5GC, E-UTRA connected to EPC, and LTE connected to EPC.

The disclosed mechanism may be applied for UEs in public networks, or in private networks (e.g., non-public network (NPN), standalone NPN (SNPN), public network integrated NPN (PNI-NPN)).

The disclosed mechanism may be used for licensed spectrum and/or unlicensed spectrum.

System information (SI) may refer to MIB, SIB1, and other SI. Minimum SI may include MIB and SIB1. Other SI may refer to SIB3, SIB4, SIB5, and other SIB(s) (e.g., SNPN-specific SIB, PNI-NPN-specific SIB, power-saving-specific SIB). The UE may receive the SI either via broadcast or via unicast. In response to the UE's system information request, the UE may receive the requested SI either via broadcast or via unicast.

Dedicated (RRC) signaling may refer to (but is not limited to) RRC message(s). For example, such RRC messages may include RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration Complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message (e.g., UE Assistance Information NR message, UE Assistance Information EUTRA message), UE Capability Enquiry message, UE Capability Information message, UE Information Request message, and UE Information Response message.

An RRC_CONNECTED UE, RRC_INACTIVE UE, and RRC_IDLE UE may apply the disclosed implementations.

An RRC_CONNECTED UE may be configured with an active BWP with common search space configured to monitor system information or paging.

Generally, the disclosed mechanism may be applied for the PCell and the UE. In some implementations, the proposed mechanism may be applied for the PSCell and the UE.

DCI may refer to a PDCCH resource scrambled by (or addressed to) an RNTI. Alternatively, the implementations regarding DCI may be applied for a physical signal.

Power Saving Enhancement

User experience is key to 5G/NR success, not only in terms of experienced data rates and latency but also importantly UE power consumption. UE power-saving enhancements are therefore vital to the success of the 5G/NR. Several power-saving schemes have been discussed, including power-saving signal/DCI as enhancement to connected-mode DRX (cDRX), additional adaptations to maximum MIMO layer number, SCell dormancy behavior and cross-slot scheduling as enhancements to BWP framework, RRM relaxation as enhancements for idle/inactive-mode power consumption, and UE assistance information.

However, additional enhancements are required to address outstanding issues, namely idle/inactive-mode power consumption in NR Standalone (SA) deployments, considering both eMBB UEs and Reduced Capability NR devices, connected-mode power consumption with FR2 (e.g., frequency above 6 GHz) deployments, and optimizing network utilization of UE assistance information.

Paging

Paging allows the network to reach a UE in an RRC_IDLE state or an RRC_INACTIVE state through a paging message. Paging may also allow the network to notify a UE in RRC_IDLE, RRC_INACTIVE, or RRC_CONNECTED state of a system information change and ETWS/CMAS indications through a short message. Both the paging message and the short message are addressed with P-RNTI on PDCCH. The paging message is transmitted on a PCCH, whereas the short message is transmitted on the PDCCH directly. A UE “in the RRC_IDLE state” is also referred to as a UE “in RRC_IDLE” in the present disclosure. Similarly, “in the RRC_INACTIVE state” is also referred to as “in RRC_INACTIVE”, and “in the RRC_CONNECTED state” is also referred to as “in RRC_CONNECTED”.

While in RRC_IDLE the UE may monitor the paging channels for CN-initiated paging; while in RRC_INACTIVE the UE may also monitor paging channels for RAN-initiated paging. The UE need not monitor paging channels continuously, however; paging DRX is defined where the UE in RRC_IDLE or RRC_INACTIVE is only required to monitor paging channels during one paging occasion (PO) per DRX cycle, which is specified in TS 38.304. The paging DRX cycles may be configured by the network as follows:
For CN-initiated paging, a default cycle may be broadcast in system information;
For CN-initiated paging, a UE-specific cycle may be configured via NAS signaling; and
For RAN-initiated paging, a UE-specific cycle may be configured via RRC signaling.

The UE may use the shortest of the DRX cycles applicable. In one implementation, a UE in RRC_IDLE may use the shortest of the first two cycles related to CN-initiated paging, while a UE in RRC_INACTIVE may use the shortest of the three cycles above.

The POs of a UE are derived based on the UE ID, and therefore POs for CN-initiated paging may overlap with POs for RAN-initiated paging. The number of different POs in a DRX cycle may be configurable via the system information and a network may distribute UEs to those POs based on their UE IDs.

When in RRC_CONNECTED, the UE may monitor the paging channels in any PO indicated in the system information for SI change indication and PWS notification. In case of BA, a UE in RRC_CONNECTED may only monitor paging channels on the active BWP with a common search space configured.

For operation with shared spectrum channel access, a UE may be configured for an additional number of PDCCH monitoring occasions in its PO to monitor for paging. However, when the UE detects a PDCCH transmission within the UE's PO addressed with P-RNTI, the UE is not required to monitor the subsequent PDCCH monitoring occasions within this PO.

DRX in RRC_IDLE and/or RRC_INACTIVE

The UE may use DRX in RRC_IDLE and/or RRC_INACTIVE in order to reduce power consumption.

The UE may monitor one PO per DRX cycle. A PO may be a set of PDCCH monitoring occasions and may include multiple time units (e.g., slot, subframe, OFDM symbol, etc.) in which paging DCI may be transmitted, as specified in TS 38.213. One paging frame (PF) is one radio frame and may contain one or multiple PO(s) or a starting point of a PO.

In multi-beam operations, the UE assumes that the same paging message and the same short message are repeated in all transmitted beams, and thus the selection of the beam(s) for the reception of the paging message and the short message is up to UE implementation. The paging message is the same for both RAN-initiated paging and CN-initiated paging.

In one implementation, the UE may initiate an RRC connection resume procedure upon receiving a RAN-initiated paging. If the UE receives a CN-initiated paging in the RRC_INACTIVE state, the UE may move to the RRC_IDLE state and inform NAS.

DRX in RRC_CONNECTED

The PDCCH monitoring activity of the UE in RRC connected mode may be governed by DRX.

When DRX is configured, the UE may not have to continuously monitor PDCCH. DRX may be characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (e.g., not for retransmissions);
retransmission-timer: duration until a retransmission can be expected;
cycle: specifies the periodic repetition of the on-duration followed by a possible period of inactivity;
active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

System Information

System Information (SI) includes a MIB and a number of SIBs, which are divided into Minimum SI and Other SI:

Minimum SI comprises basic information required for initial access and information for acquiring any other SI. Minimum SI includes:

MIB contains cell barred status information and essential physical layer information of the cell required to receive further system information, e.g., CORESET #0 configuration. MIB is periodically broadcast on BCH.

SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.

Other SI encompasses all SIBs not broadcast in the Minimum SI. Those SIBs can either be periodically broadcast on DL-SCH, broadcast on-demand on DL-SCH (e.g., upon request from UEs in RRC_IDLE or RRC_INACTIVE), or RRC_CONNECTED, or sent in a dedicated manner on DL-SCH to UEs in RRC_CONNECTED (e.g., upon request from UEs in RRC_CONNECTED or when the UE has an active BWP with no common search space configured).

Power Saving Configuration

For UE power saving (but not limited thereto), the serving cell (or gNB) may configure the UE (in RRC_IDLE, RRC_INACTIVE, and/or RRC_CONNECTED) with at least one power saving configuration. In some implementations, the serving cell (or gNB) may configure the UE with multiple power saving configurations. For example, the UE may be configured with a first power saving configuration and a second power saving configuration. Parameters in the first power saving configuration may be the same as or different from parameters in the second power saving configuration.

Power saving configuration may include a set of parameters for the UE to apply so that the UE (or the network) may operate in a power-saving manner. The set of parameters in the power saving configuration may include DRX configuration (e.g., DRX-Config IE), paging-related configuration (e.g., PCCH-Config IE), PDCCH monitoring-related configuration (e.g., PDCCH-Config), and any parameters required to configure the UE to operate in a power-saving manner/mode.

DRX configuration may include at least one of the following IEs/fields/information: DRX on duration timer (e.g., drx-onDurationTimer IE), DRX inactivity timer (e.g., drx-InactivityTimer IE), DRX HARQ RTT DL timer (e.g., drx-HARQ-RTT-TimerDL IE), DRX HARQ RTT UL timer (e.g., drx-HARQ-RTT-TimerUL IE), DRX DL retransmission timer (e.g., drx-RetransmissionTimerDL IE), DRX UL retransmission timer (e.g., drx-RetransmissionTimerUL IE), DRX long cycle start offset (e.g., drx-LongCycleStartOffset IE), DRX short cycle (e.g., drx-ShortCycle IE), DRX short cycle timer (e.g., drx-ShortCycleTimer IE), and DRX slot offset (e.g., drx-SlotOffset IE).

Paging-related configuration may include at least one of the following IEs/fields/information: paging cycle (e.g., DRX cycle, defaultPagingCycle IE, ran-PagingCycle IE, PagingCycle IE), first PDCCH monitoring occasion for paging of each PO of the PF (e.g., firstPDCCH-MonitoringOccasionOfPO IE), an offset used by the UE to derive the number of total paging frames in the paging cycle (corresponding to parameter N used in PF/PO formula in 3GPP TS 38.304 v16.0.0) and paging frame offset (corresponding to parameter PF_offset used in PF/PO formula in 3GPP TS 38.304 v16.0.0) (e.g., nAndPagingFrameOffset IE), number of paging occasions per paging frame (e.g., ns IE), and the number of PDCCH monitoring occasions corresponding to an SSB for paging (e.g., nrofPDCCHMonitoringOccasionPerSSB IE).

PDCCH-related configuration may include at least one of the following IEs/fields/information: Control Resource Set (CORESET), search space list, first PDCCH monitoring occasion of PO, paging search space, etc.

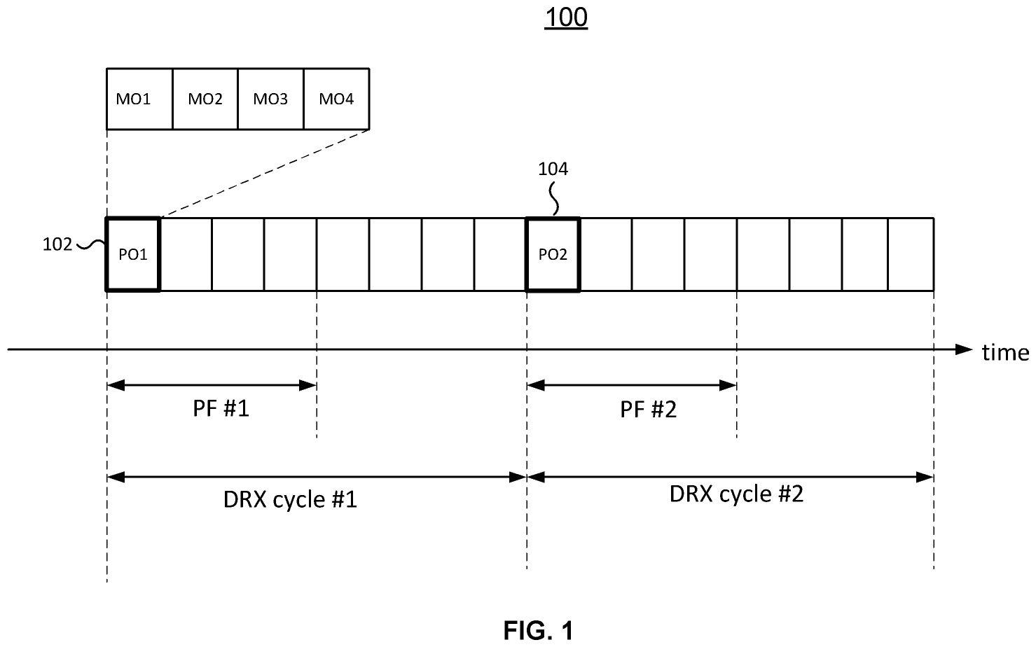

In order to reduce power consumption, a DRX mechanism may be applied for paging monitoring (e.g., PDCCH monitoring for paging). The UE does not need to monitor the PDCCH continuously. FIG. 1 illustrates a DRX mechanism for paging monitoring 100 according to an example implementation of the present disclosure. The UE may be configured with a DRX cycle and several parameters for the determination of the PO. The UE may only monitor one PO per DRX cycle. In some cases (e.g., multi-beam operation, operation with shared spectrum channel access, etc.), the UE may monitor multiple PDCCH monitoring occasions (which is referred to as “MO” in the present disclosure) in one PO. As illustrated in FIG. 1, the UE monitors PO1 102 in DRX cycle #1 and monitors PO2 104 in DRX cycle #2. There is a PF #1 in the DRX cycle #1 and a PF #2 in the DRX cycle #2. The UE monitors four PDCCH monitoring occasions, including MO1, MO2, MO3, MO4, in PO1 102. In one implementation, a PO may include S consecutive PDCCH monitoring occasions, where S is the number of actual transmitted SSBs determined according to ssb-PositionslnBurst in the SIB1. The K^{th} PDCCH monitoring occasion for paging in the PO corresponds to the K^{th} transmitted SSB, where K is an integer. In one implementation, a configuration related to MO for paging may include at least one of the following IEs: pagingSearchSpace, firstPDCCH-MonitoringOccasionOfPO, and nrofPDCCH-MonirotingOccasionPerSSB-InPO, the number of MOs per PO (which may correspond to the number of transmitted SSBs).

However, even though the UE only needs to monitor the PDCCH monitoring occasions configured by the NW, there is still some unnecessary PDCCH monitoring for paging (e.g., on paging occasion). For instance, the UE should monitor each PO (and/or the corresponding MOs within the PO) periodically to attempt to receive possible paging. However, the paging for the UE may not be regularly transmitted. For example, the paging may only be transmitted once in a long time period. Based on the current DRX mechanism, the UE will waste power to monitor the POs in cases that there is no paging and/or there is a paging but not indicated for the UE. To be more specific, the UE may waste power receiving the corresponding paging message indicated by the paging DCI, where the UE ID field included in the paging message does not match the UE ID, which may be a false alarm. Implementations are disclosed below to reduce the unnecessary PDCCH monitoring for paging (e.g., on paging occasion).

In general, the UE monitors the PDCCH monitoring occasions for paging periodically. One way to reduce the PDCCH monitoring activities is to let UE skip some PDCCH monitoring occasions that may not need to be monitored. For example, if the NW does not want to page the UE at a PDCCH monitoring occasion (e.g., PO), the UE may not be required to wake up to monitor the PDCCH monitoring occasion, e.g., the UE could skip monitoring the PDCCH monitoring occasion. Another way is that the UE may only wake up to monitor the PDCCH when the paging (e.g., paging DCI and/or paging message) for the UE has a chance to be received. Otherwise, the UE may go to sleep (e.g., not monitor the PDCCH) for power saving. In short, the UE does not need to monitor paging (e.g., paging DCI and/or paging message) periodically on each PDCCH monitoring occasion, PO and/or DRX cycle. Implementations are disclosed below to achieve the purpose of reducing the PDCCH monitoring activities.

Indicator for Power Saving Information

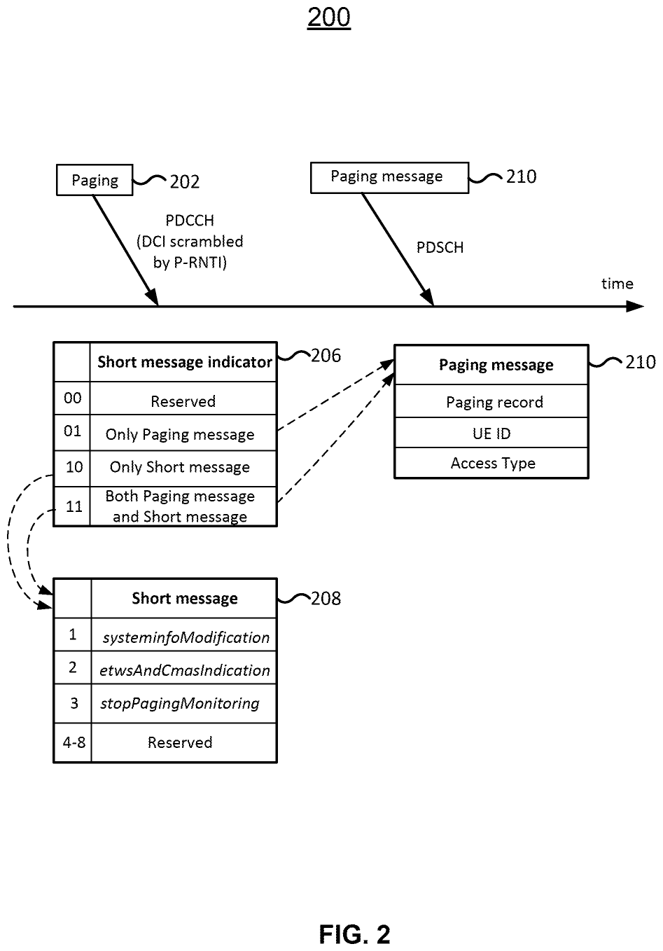

Paging allows the NW to reach UEs through a paging message and notify UEs of system information change and/or ETWS/CMAS indications through a short message. FIG. 2 illustrates a paging process 200 according to an example implementation of the present disclosure. The UE may monitor a PDCCH (e.g., on PO) to receive a short message indicator 206/short message 208 from the NW via paging DCI 202 (e.g., DCI format 1_0 scrambled by a P-RNTI) while the UE is in RRC_IDLE/RRC_INACTIVE. The paging DCI may indicate to the UE to receive a paging message 210 on a PDSCH. The NW may use these signaling, e.g., paging DCI 202, short message indicator 206, short message 208, and/or paging message 210, to indicate some information for power saving, such as how to skip PDCCH monitoring (e.g., on PDCCH monitoring occasions(s) and/or PO). Implementations of the information for power saving are disclosed below. In one implementation, the information may be associated with a power saving configuration (or its parameter) mentioned previously, such as DRX configuration, paging-related configuration, and/or PDCCH-related configuration.

Paging DCI (e.g., DCI Scrambled by P-RNTI)

The following information may be transmitted by means of the DCI format 1_0 with CRC scrambled by P-RNTI:
Short Messages Indicator—2 bits according to Table 7.3.1.2.1-1 in the 3GPP TS 38.212 or Table 1 below.
Short Messages—8 bits, according to Clause 6.5 of the 3GPP TS 38.331. If only the scheduling information for Paging is carried, this bit field is reserved.
Frequency domain resource assignment—┌log₂(N_{RB}^{DL,BWP}(N_{RB}^{DL,BWP}+1)/2)┐bits. If only the short message is carried, this bit field is reserved. N_{RB}^{DL,BWP} is the size of CORESET 0
Time domain resource assignment—4 bits as defined in Clause 5.1.2.1 of the 3GPP TS 38.214. If only the short message is carried, this bit field is reserved.
VRB-to-PRB mapping—1 bit according to Table 7.3.1.2.2-5. If only the short message is carried, this bit field is reserved.
Modulation and coding scheme—5 bits as defined in Clause 5.1.3 of the 3GPP TS 38.214. If only the short message is carried, this bit field is reserved.
TB scaling—2 bits as defined in Clause 5.1.3.2 of the 3GPP TS 38.214. If only the short message is carried, this bit field is reserved.
Reserved bits—8 bits for operation in a cell with shared spectrum channel access; otherwise, 6 bits.

The one or multiple reserved bits of the paging DCI may be utilized for indicating the information for power saving. In one implementation, the information may be associated with a power saving configuration (or its parameter) mentioned previously, such as DRX configuration, paging-related configuration, and/or PDCCH-related configuration. In one implementation, the paging DCI may indicate how to skip PDCCH monitoring (e.g., on PDCCH monitoring occasions(s) and/or PO).

Table 1 illustrates an example short message indicator included in the DCI scrambled by the P-RNTI.

TABLE 1

| Bit field | Short Message indicator |
|---|---|
| 00 | Reserved |
| 01 | Only scheduling information for Paging is present in the DCI |
| 10 | Only short message is present in the DCI |
| 11 | Both scheduling information for Paging and short message |
| | are present in the DCI |

A short message indicator may include two bits, which may indicate four possible values. The bit value “01” may indicate that only a paging message is present, the bit value “10” may indicate that only a short message is present, and the bit value “11” may indicate that both the paging message and the short message are present. The bit value “00” may be reserved. In one implementation, the reserved bit value of the short message indicator (e.g., “00”) may be utilized for indicating the information for power saving. In one implementation, the information may be associated with a power saving configuration (or its parameter) mentioned previously, such as DRX configuration, paging-related configuration, and/or PDCCH-related configuration. In one implementation, the short message indicator may indicate how to skip PDCCH monitoring (e.g., on PDCCH monitoring occasions(s) and/or PO).

Short Message

Short messages can be transmitted on PDCCH using P-RNTI with or without an associated Paging message using a Short Message field in DCI format 1_0 (see TS 38.212, clause 7.3.1.2.1).

Table 2 illustrates an example short message, where bit #1 is the most significant bit.

TABLE 2

| Bit | Short Message |
|---|---|
| 1 | systemInfoModification |
| | If set to 1: indication of a BCCH modification other than |
| | SIB6, SIB7 and SIB8. |
| 2 | etwsAndCmasIndication |
| | If set to 1: indication of an ETWS primary notification and/or an |
| | ETWS secondary notification and/or a CMAS notification. |
| 3 | stopPagingMonitoring |
| | If set to 1: stop monitoring PDCCH occasions(s) for paging |
| | in this PO. |
| 4-8 | Not used in this release of the specification, and shall be |
| | ignored by UE if received. |

A short message may include eight bits, including bit #1 to bit #8. Bit #1 may indicate system information modification (systeminfoModification), bit #2 may indicate ETWS and CMAS indication (etwsAndCmasIndication), and bit #3 may indicate stop paging monitoring (stopPagingMonitoring). Bit #4 through bit #8 of the short message may be reserved. In one implementation, the reserved bits of the short message (e.g., bit #4 through bit #8) may be utilized for indicating the information for power saving. In one implementation, the information may be associated with a power saving configuration (or its parameter) mentioned previously, such as DRX configuration, paging-related configuration, and/or PDCCH-related configuration. In one implementation, the short message may indicate how to skip PDCCH monitoring (e.g., on PDCCH monitoring occasions(s) and/or PO).

In one implementation, an existing indicator may be reused (or re-interpreted) as an implicit signaling to indicate the information for power saving. In one implementation, stopPagingMonitoring may be used to indicate the information for power saving. Currently, the stopPagingMonitoring is used to stop monitoring PDCCH monitoring occasion(s) for paging in one PO. The stopPagingMonitoring may be reused (re-interpreted) to stop monitoring PDCCH monitoring occasion(s) for paging in (following) multiple POs, which may be in the same DRX cycle or in different DRX cycles. In one implementation, the UE may apply the behavior for PDCCH monitoring based on the indicator (e.g., stopPagingMonitoring) and/or the information for power saving disclosed in the present disclosure. For example, based on the indicator (e.g., stopPagingMonitoring), the UE may stop monitoring one or more POs and/or stop monitoring the following PDCCH monitoring occasions in the same PO or in different POs, which may be in the same DRX cycle or in different DRX cycle(s). In one implementation, the information may be associated with a power saving configuration (or its parameter) mentioned previously, such as DRX configuration, paging-related configuration, and/or PDCCH-related configuration.

Paging Message

In one implementation, a cell-specific paging message may indicate the information for power saving. For example, when the UE receives the paging message, the UE may not need to check whether the ue-Identity included in the PagingRecord matches the UE identity allocated by upper layers or the UE's stored full-RNTI. The UE may apply the behavior for PDCCH monitoring based on the indicator/information included in the cell-specific paging message and/or the information for power saving disclosed in the present disclosure. In one implementation, the information may be associated with a power saving configuration (or its parameter) mentioned previously, such as DRX configuration, paging-related configuration, and/or PDCCH-related configuration. In one implementation, the paging message may indicate how to skip PDCCH monitoring (e.g., on PDCCH monitoring occasions(s) and/or PO).

In one implementation, a UE-specific paging message may indicate the information for power saving. For example, when the UE receives the paging message, the UE may need to check whether the ue-Identity included in the paging message (e.g., a specific record and/or PagingRecord) matches the UE identity allocated by upper layers or the UE's stored fullI-RNTI. If yes, the UE may apply the behavior for PDCCH monitoring based on the indicator/information included in the UE-specific paging message and/or the information for power saving disclosed in the present disclosure. If not, the UE may ignore the indicator. In one implementation, the information may be associated with a power saving configuration (or its parameter) mentioned previously, such as DRX configuration, paging-related configuration, and/or PDCCH-related configuration. For example, when the UE receives the paging message, the UE may need to check whether the ue-Identity included in a new UE Record (e.g., a UE record for the power-saving purpose) matches the UE identity allocated by upper layers or the UE's stored fullI-RNTI. If yes, the UE may apply the behavior for PDCCH monitoring based on the indicator/information included in the UE-specific paging message and/or the information for power saving disclosed in the present disclosure. If not, the UE may ignore the indicator.

In one implementation, a paging message may indicate the information for power saving, where the paging message may include UE-specific configuration (e.g., a new UE record and/or PagingRecord) and cell-specific configuration. In one implementation, the information for power saving may be included in the cell-specific configuration in the paging message. For example, when the UE receives the paging message, if the paging message includes the information, the UE may apply the behavior for PDCCH monitoring based on the indicator/information included in the cell-specific configuration and/or the information for power saving disclosed in the present disclosure. For example, when the UE receives the paging message, if the paging message does not include the information and if the UE has applied or has not yet applied the behavior for PDCCH monitoring based on indicator/information included in the cell-specific configuration and/or the information for power saving disclosed in the present disclosure, the UE may not apply the behavior for PDCCH monitoring based on the information for power saving described in the present disclosure. For another example, when the UE receives the paging message, if the paging message includes the information and if the ue-Identity included in the new UE Record and/or PagingRecord matches the UE identity allocated by upper layers or the UE's stored fullI-RNTI, the UE may apply the behavior for PDCCH monitoring based on the indicator/information included in the UE-specific configuration and/or the information for power saving disclosed in the present disclosure. For another example, when the UE receives the paging message, if the paging message includes the information, and if the ue-Identity included in the new UE Record and/or PagingRecord does not match the UE identity allocated by upper layers or the UE's stored fullI-RNTI, the UE may apply the behavior for PDCCH monitoring based on the indicator/information included in the cell-specific configuration and/or one or more of the information for power saving disclosed in the present disclosure.

The Paging message is used for the notification of one or more UEs.
Signaling radio bearer: N/A
RLC-SAP: TM
Logical channel: PCCH
Direction: Network to UE

Table 3 illustrates a data structure of an example paging message

TABLE 3
-- ASN1START
-- TAG-PAGING-START

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | SEQUENCE{ } |

OPTIONAL
}

| | |
|---|---|
| PagingRecordList ::= | SEQUENCE (SIZE(1..maxNrofPageRec)) OF |

PagingRecord

| | |
|---|---|
| PagingRecord ::= | SEQUENCE { |
| ue-Identity | PagingUE-Identity, |
| accessType | ENUMERATED {non3GPP} OPTIONAL, |

-- Need N
...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

The field accessType in the PagingRecord may indicate whether the Paging message is originated due to the PDU sessions from the non-3GPP access.

System Information

Furthermore, if the short message indicator (included in the DCI) indicates that there is a short message carried in the DCI, and the systemInfoModification bit of the short message is set (e.g., equal to ‘1’), the UE may apply the SI acquisition procedure (as specified in TS 38.331) to acquire one or multiple system information (e.g., MIB, SIBx).

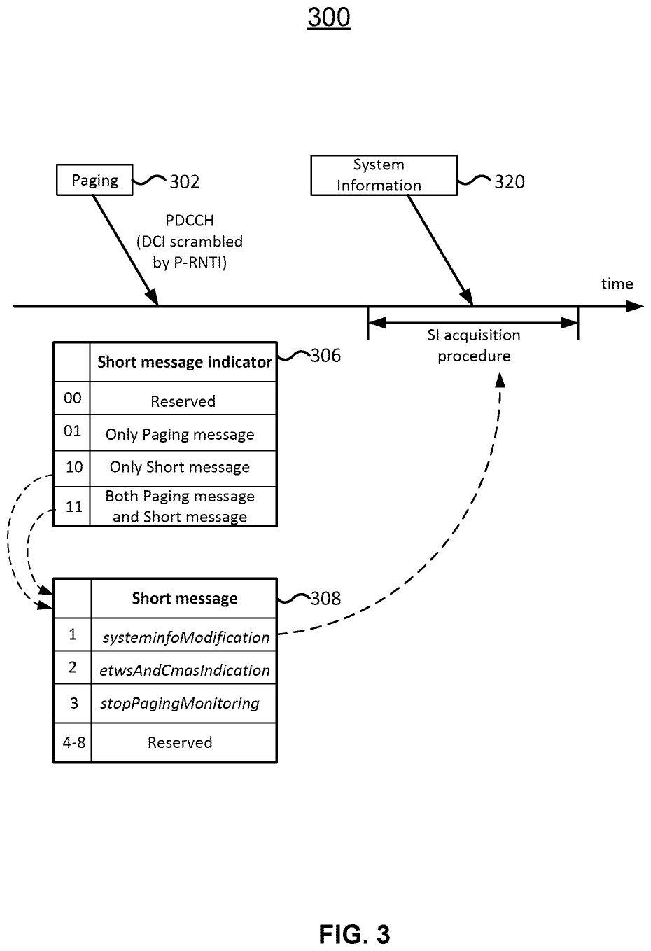

The UE may receive the system information from the NW while the UE is in RRC_IDLE/RRC_INACTIVE. FIG. 3 illustrates an SI acquisition procedure 300 according to an example implementation of the present disclosure. A UE may monitor the PDCCH to receive paging DCI 302 scrambled by a P-RNTI (e.g., DCI format 1_0). When the UE receives the paging DCI 302, the UE may check a short message indicator 306 included in the paging DCI 302 to know if there is a short message 308 carried in the paging DCI 302 and check if there is scheduling information for a paging message. An example of the bit values of the short message indicator 306 is illustrated in Table 1 disclosed previously. An example format of the short message 308 is illustrated in Table 2 disclosed previously. If the short message indicator 306 indicates that the short message 308 is present and the short message 308 indicates system information modification, the UE may perform an SI acquisition procedure to receive system information 320. The system information 320 may include the information for power saving. The NW may use the system information 320 explicitly and/or implicitly to indicate the information for power saving, such as reducing PDCCH monitoring in RRC_IDLE/RRC_INACTIVE. In one implementation, the information may be associated with a power saving configuration (or its parameter) mentioned previously, such as DRX configuration, paging-related configuration, and/or PDCCH-related configuration. In one implementation, the system information may indicate how to skip PDCCH monitoring (e.g., on PDCCH monitoring occasions(s) and/or PO).

UE Group ID

In one implementation, the DCI (e.g., paging DCI)/short message indicator/short message/paging message/system information may be a UE group-specific message. For example, multiple UEs may be separated into different UE groups. The UE may be allocated/indicated a UE group ID from the NW (e.g., RAN and/or CN) (via RRC configuration, RRC release (with/without suspend configuration), etc.). The DCI (e.g., paging DCI)/short message indicator/short message/paging message/system information may indicate at least a UE group ID. The UE may be aware that whether the information (e.g., how to skip PDCCH monitoring (e.g., on PDCCH monitoring occasions(s) and/or PO)) in the DCI (e.g., paging DCI)/short message indicator/short message/paging message/system information is for the UE (or the group to which the UE belongs) based on the UE group ID. In one implementation, a group of UEs may be formed based on at least one of the following elements/fields/information:
UE ID. For example, the NW may equally distribute the UEs to several UE groups based on their UE ID. The UE may be allocated/indicated a UE group ID from the NW (e.g., RAN and/or CN).
UE service type/characteristic, for example, based on QoS or eMBB/URLLC/eMTC UE.
UE's required/supported/registered slice (e.g., network slice, RAN slice), for example, based on the UE's required/supported/registered slice(s), where each slice may be identified by an S-NSSAI.
UE capability. For example, the reduced capability UE may be associated with a specific UE group. In another example, the NW may determine the group based on a set of the UE capabilities.
UE assistance information, for example, some UE's preferences, or the combination of some UE assistance information. The UE assistance information may be transmitted to the NW (e.g., RAN and/or CN) by the UE.
Paging probability. The paging probability information may be negotiated between the UE and the NW (e.g., RAN and/or CN, 5GC) via RRC signaling and/or NAS signaling.
Frequency range (e.g., FR1/FR2).
UE's RRC state (e.g., RRC_IDLE, RRC_INACTIVE, RRC_CONNECTED).
UE's channel condition, e.g., based on measurement result of SSB/CSI-RS (via RSRP and/or SINR).
UE's area. For example, the UE may know its area based on some geographic information.

RRC Message

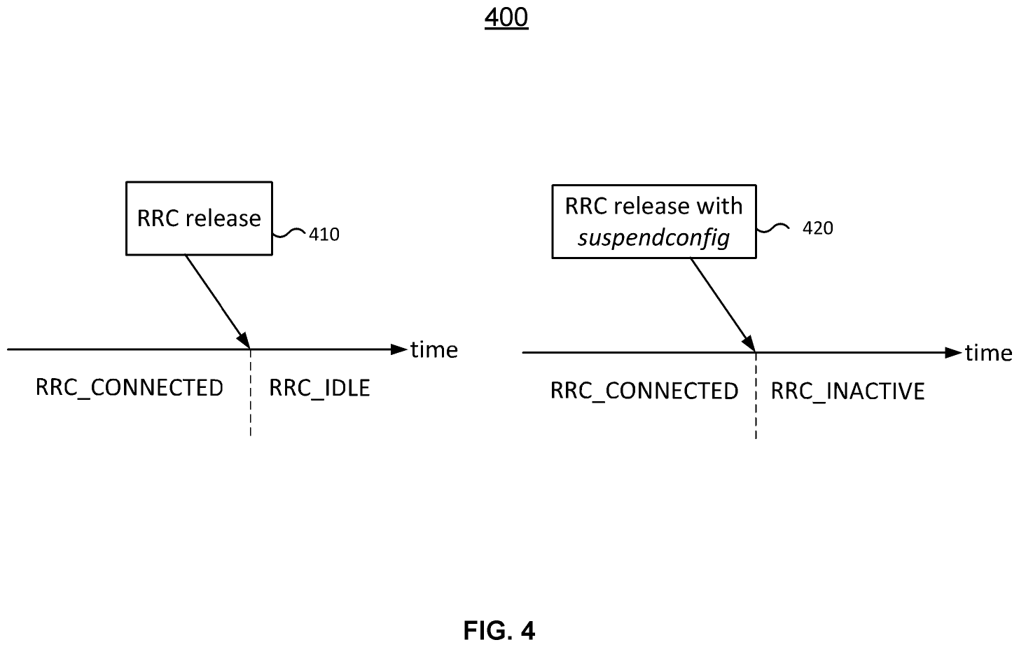

FIG. 4 illustrates a method 400 for indicating the information for power saving via an RRC release message according to an example implementation of the present disclosure. The NW may transmit an RRC release message 410 to ask the UE to enter the RRC_IDLE state. The RRC release message 410 may indicate the information for power saving. The NW may transmit an RRC release message 420 including suspendconfig to ask the UE to enter the RRC_INACTIVE state. The RRC release message 420 including suspendconfig may indicate the information for power saving. The NW may use the RRC release message 410 without suspendconfig or the RRC release message 420 with suspendconfig explicitly and/or implicitly to indicate the information for power saving, such as reducing PDCCH monitoring in RRC_IDLE/RRC_INACTIVE. In one implementation, the information for power saving may only be applied when the UE is in RRC_INACTIVE if the UE receives the information for power saving via the RRC release message 420 with suspendconfig. In one implementation, the information may be associated with a power saving configuration (or its parameter) mentioned previously, such as DRX configuration, paging-related configuration, and/or PDCCH-related configuration. In one implementation, the RRC release message 410 or the RRC release message 420 with suspendconfig may indicate how to skip PDCCH monitoring (e.g., on PDCCH monitoring occasions(s) and/or PO).

In one implementation, the NW may transmit a specific RRC message (e.g., newly introduced for power saving in RRC_IDLE/RRC_INACTIVE) explicitly and/or implicitly to indicate the information for power saving, such as reducing PDCCH monitoring in RRC_IDLE/RRC_INACTIVE. In one implementation, the information may be associated with a power saving configuration (or its parameter) mentioned previously, such as DRX configuration, paging-related configuration, and/or PDCCH-related configuration. In one implementation, the specific RRC message may indicate how to skip PDCCH monitoring (e.g., on PDCCH monitoring occasions(s) and/or PO).

Information for Power Saving

The indicator (e.g., the DCI (e.g., paging DCI)/short message indicator/(an indicator in) the short message/(an indicator in) the paging message/(an indicator in) the system information/(an indicator in) a pre-configured RRC message) may indicate to the UE to skip monitoring the PO(s) and/or PDCCH monitoring occasion(s). The PO(s)/PDCCH monitoring occasion(s) that the UE is asked to skip monitoring via the indicator may be in the same DRX cycle. The PO(s)/PDCCH monitoring occasion(s) that the UE is asked to skip monitoring via the indicator may span across different DRX cycles.

In one implementation, the UE may apply the behavior for PDCCH monitoring (reduction) based on an instruction indicated via the indicator. For example, the UE may determine whether to skip monitoring the PO(s) and/or PDCCH monitoring occasion(s) based on the value of (the instruction provided by) the indicator. In one implementation, the UE may continue skipping monitoring the PO(s) and/or PDCCH monitoring occasion(s) for a duration if the instruction is set (e.g., with a bit value equal to ‘1’).

In one implementation, the UE may continue monitoring (e.g., not skip) the PO(s) and/or PDCCH monitoring occasion(s) if the instruction is not set (e.g., with a bit value equal to ‘0’) or not configured.

In one implementation, the UE may be configured some information for power saving via a first indicator (e.g., system information and/or RRC message), and the NW may indicate the usage of the information for power saving via a second indicator (e.g., DCI (e.g., paging DCI), short message indicator, short message, and/or paging message). In one implementation, the first indicator may indicate a set and/or a list of configurations. In one implementation, the first indicator may indicate a set of time durations in which the UE skips monitoring PDCCH monitoring occasions or POs. The set of time durations may include one or more time durations. In one implementation, the second indicator may indicate one configuration (e.g., via an ID or a flag) selected from the set and/or the list of configurations. In one implementation, the second indicator may indicate one time duration selected from the set of time durations. The UE may skip monitoring PDCCH monitoring occasions or POs based on the time duration indicated by the second indicator. In one implementation, the information may be associated with a power saving configuration (or its parameter) mentioned previously, such as DRX configuration, paging-related configuration, and/or PDCCH-related configuration.

The Number of PO, PDCCH Monitoring Occasions, PFs, and/or DRX Cycles

In one implementation, the indicator (the information for power saving) may indicate the number of POs, PDCCH monitoring occasions, PFs, and/or DRX cycles in which the UE skips monitoring the PDCCH.

In one implementation, the indicator may be used to indicate how many POs, PDCCH monitoring occasions for paging, PFs, and/or DRX cycles that the UE could skip monitoring PDCCH.

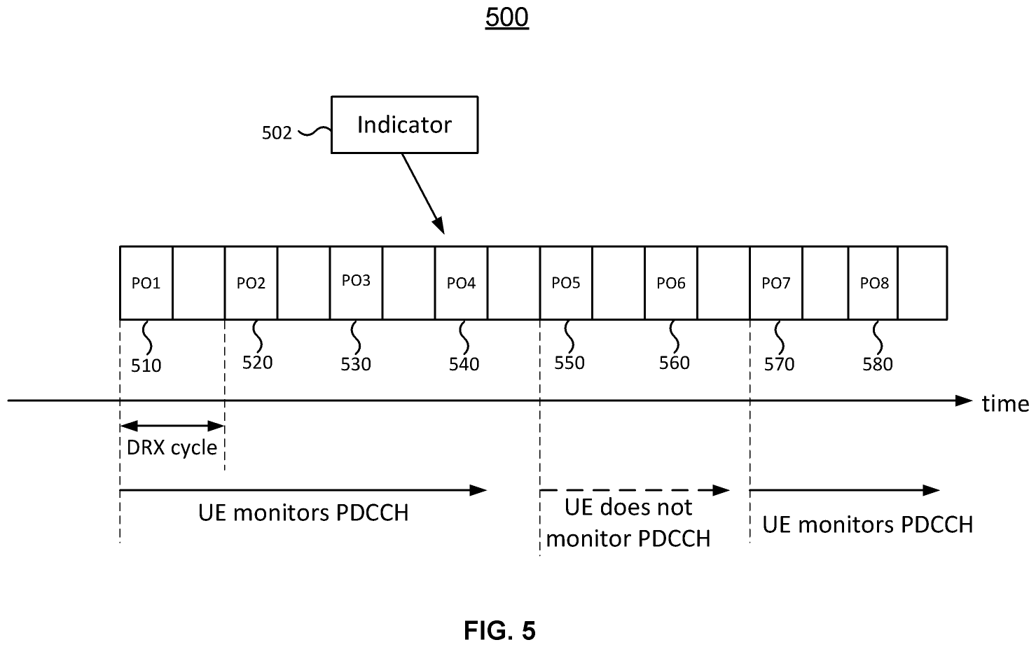

FIG. 5 illustrates a process 500 of skipping monitoring multiple PDCCH monitoring occasions and/or paging occasions according to an example implementation of the present disclosure. The UE receives an indicator 502 including the information for power saving. In one implementation, the indicator 502 may indicate to the UE to skip monitoring 2 POs/DRX cycles. When the UE receives the indicator 502, the UE may stop monitoring the next 2 POs/DRX cycles, and then start monitoring the POs after the next 2 PO/DRX cycles. As illustrated in FIG. 5, the UE monitors PDCCH in PO1 510, PO2 520, PO3 530, and PO4 540. The UE receives the indicator 502 in the PO4 540. The indicator 502 indicates a time duration of 2 POs/DRX cycles. The UE then skips monitoring PDCCH in PO5 550 and PO6 560. After the indicated time duration (2POs/DRX cycles) is over, the UE continues to monitor PDCCH in PO7 570 and PO8 580.

In one implementation, the number of POs, PDCCH monitoring occasions for paging, PFs, and/or DRX cycles may be pre-configured, e.g., configured by system information and/or RRC message. In one implementation, the number of POs, PDCCH monitoring occasion, PFs, and/or DRX cycles may be indicated via the indicator, e.g., the DCI (e.g., paging DCI)/short message indicator/(an indicator in) the short message/(an indicator in) the paging message/(an indicator in) the system information/(an indicator in) a pre-configured RRC message.

In one implementation, the UE may maintain a counter to count the number of POs, PDCCH monitoring occasions, PFs, and/or DRX cycles. The maximum value of the counter may correspond to the number of POs, PDCCH monitoring occasions, PFs, and/or DRX cycles indicated by the NW. The UE may reset the counter to the initial value when the UE receives the indicator from the NW. For example, the initial value of the counter may be zero. The UE may increase the counter by one if the UE skips one PO, PDCCH monitoring occasion, PF, and/or DRX cycle. If the counter reaches to the maximum value, the UE may not skip monitoring the PO, PDCCH monitoring occasion, PF, and/or DRX cycle. For another example, the initial value of the counter may be the maximum value indicated/configured by the NW. The UE may decrease the counter by one if the UE skips one PO, PDCCH monitoring occasion, PF, and/or DRX cycle. If the counter reaches zero, the UE may not skip monitoring the PO, PDCCH monitoring occasion, PF, and/or DRX cycle.

Time-Based (e.g., Time Unit, Timer)

In one implementation, the indicator may indicate a time duration in which the UE skips monitoring the PDCCH monitoring occasion(s) and/or PO(s). The indicator may indicate the time duration in a time unit of hyper system frame, system frame, radio frame, second, millisecond, slot, symbol, etc.

In one implementation, the indicator may indicate a specific number, and the UE may skip monitoring the specific number of PDCCH monitoring occasions and/or POs.

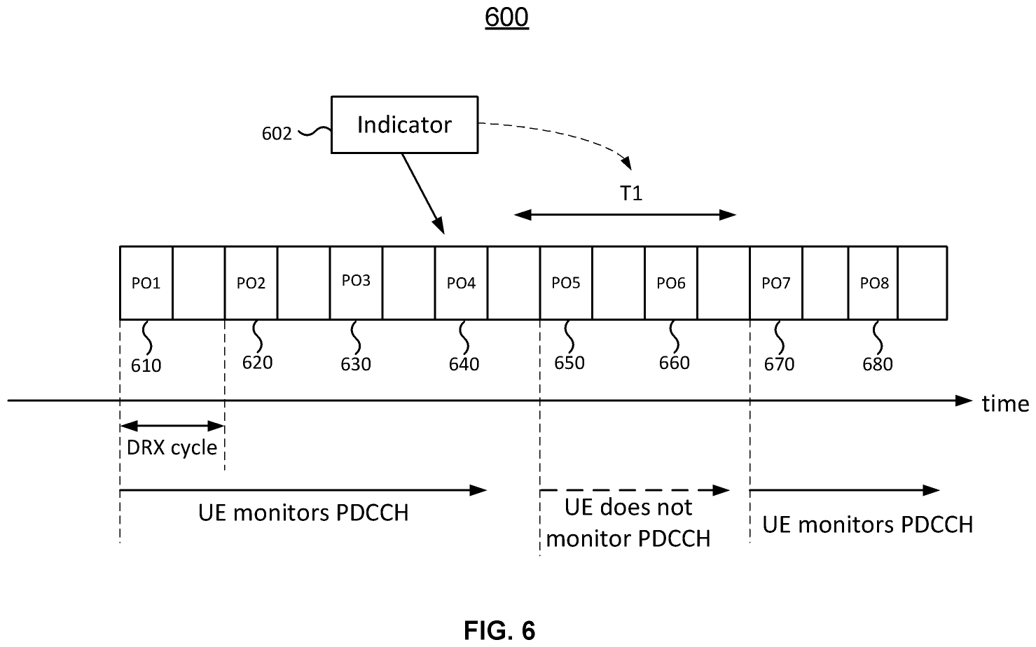

FIG. 6 illustrates a process 600 of skipping monitoring PDCCH monitoring occasions and/or POs for a time duration according to an example implementation of the present disclosure. The UE receives an indicator 602 including the information for power saving. The indicator 602 may indicate to the UE to skip monitoring for a time duration T1 represented in a (number of) time unit. For example, the time duration T1 may be represented as X hyper system frames, system frames, radio frames, seconds, milliseconds, slots, symbols, etc., where X may be a positive real number. When the UE receives the indicator 602, the UE may stop/skip monitoring the PDCCH monitoring occasions/POs for the duration T1, and then start monitoring the POs after the duration T1 is over. As illustrated in FIG. 6, the UE monitors PDCCH in PO1 610, PO2 620, PO3 630, and PO4 640. The UE receives the indicator 602 in the PO4 640. The indicator 602 indicates a time duration T1. The UE then skips monitoring PDCCH in PO5 650 and PO6 660. After the indicated time duration T1 is over, the UE continues to monitor PDCCH in PO7 670 and PO8 680.

In one implementation, the (number of) time unit(s) may be pre-configured, e.g., configured by system information and/or RRC message. In one implementation, the (number of) time unit(s) may be indicated via the indicator, e.g., the DCI (e.g., paging DCI)/short message indicator/(an indicator in) the short message/(an indicator in) the paging message/(an indicator in) the system information/(an indicator in) a pre-configured RRC message.

In one implementation, the indicator may indicate a timer (or parameters of a timer).

In one implementation, the indicator may indicate to the UE to (re-)start the timer. For example, the UE may (re-)start the timer upon receiving the indicator.

In one implementation, the UE may skip monitoring the PDCCH/PO while the timer is running.

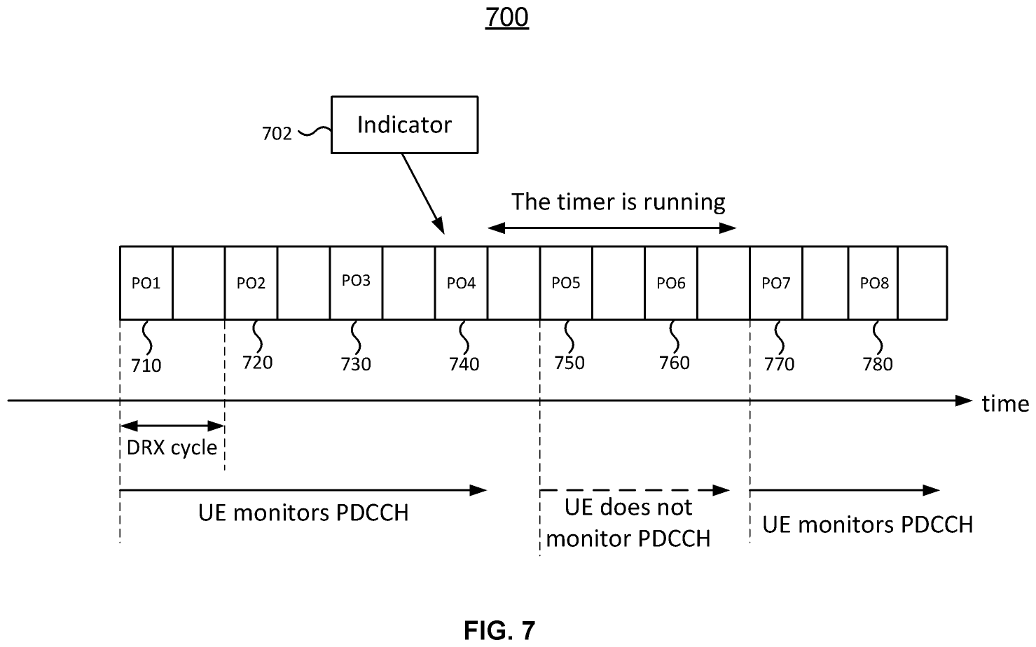

FIG. 7 illustrates a process 700 of skipping monitoring PDCCH monitoring occasions and/or POs based on a timer according to an example implementation of the present disclosure. The UE receives an indicator 702 including the information for power saving. The indicator 702 may indicate to the UE to skip monitoring while a timer is running. When the UE receives the indicator 702, the UE may (re-)start the timer. If the timer is running, the UE may skip monitoring the PDCCH. If the timer is not running, the UE may monitor the PDCCH. As illustrated in FIG. 7, the UE monitors PDCCH in PO1 710, PO2 720, PO3 730, and PO4 740. The UE receives the indicator 702 in the PO4 740 and then the UE starts or restarts the timer. The UE skips monitoring PDCCH in PO5 750 and PO6 760 because the timer is running. After the timer stops or expires, the UE continues to monitor PDCCH in PO7 770 and PO8 780.

In one implementation, (parameters of) the timer may be pre-configured, e.g., configured by system information and/or RRC message.

Parameters Used for the Calculation of PF and/or i_s

The following parameters are used for the calculation of PF:

T: DRX cycle of the UE. T is determined by the shortest of the UE-specific DRX value(s), if configured by RRC and/or upper layers, and a default DRX value broadcast in system information. In the RRC_IDLE state, if the UE-specific DRX is not configured by the upper layers, the default DRX value is applied.

N: the number of total paging frames in T.

Ns: the number of paging occasions for a PF.

PF_offset: offset used for PF determination.

In one implementation, the indicator may indicate the (change of) parameters used for the calculation of PF and/or i_s.

In one implementation, the indicator may be used to indicate T, N, Ns, PF_offset. When the UE receives the indicator, the UE may change the value of the parameters based on the indicator.

In one implementation, a time duration in which the UE applies the updated value of the parameters may be configured by the NW, such as via a timer, a counter, and/or a rule. In one implementation, the UE may apply the updated value of the parameters only during a time duration (e.g., in a time unit of hyper system frame, system frame, radio frame, second, millisecond, slot, symbol, etc.). In one implementation, the UE may apply the updated value of the parameters until receiving the next indicator. In one implementation, the UE may apply the updated value of the parameters until receiving the paging.

Search Space/CORESET/BWP/Time Resource/Frequency Resource for PDCCH Monitoring

In one implementation, the indicator may indicate a search space/CORESET/BWP in which the UE skips monitoring the PDCCH monitoring occasion and/or PO.

In one implementation, the indicator may indicate a search space/CORESET/BWP/time resource/frequency resource to which the UE may switch for skipping monitoring the PDCCH/PO.

In one implementation, the UE may monitor the PDCCH on a first search space/CORESET/BWP/time resource/frequency resource. When the UE receives the indicator, the UE may skip monitoring the PDCCH on a second search space/CORESET/BWP/time resource/frequency resource.

In one implementation, the first and/or the second search space/CORESET/BWP/time resource/frequency resource may be pre-configured, e.g., configured by system information and/or RRC message. In one implementation, the first and/or the second search space/CORESET/BWP/time resource/frequency resource may be indicated via the indicator, e.g., the DCI (e.g., paging DCI)/short message indicator/(an indicator in) the short message/(an indicator in) the paging message/(an indicator in) the system information/(an indicator in) a pre-configured RRC message).

The Time Domain Offset to Start Skipping Monitoring PDCCH Monitoring Occasions/POs

In one implementation, the UE may start skipping monitoring PDCCH monitoring occasions/POs after an offset. The offset may be represented in a time unit. The time unit may be one of hyper system frame, system frame, radio frame, second, millisecond, slot, symbol, etc. In one implementation, when the UE receives the indicator (e.g., the DCI (e.g., paging DCI)/short message indicator/(an indicator in) the short message/(an indicator in) the paging message/(an indicator in) the system information/(an indicator in) a pre-configured RRC message), after a time duration indicated by the offset, the UE may start skipping monitoring PDCCH monitoring occasion/PO.

Fallback Mechanism

The PDCCH skipping methods disclosed in the present disclosure may lead to reduction of the opportunities for monitoring PDCCH monitoring occasions/PO. In order to increase the reliability of paging, a fallback mechanism is disclosed. To be more specific, the UE may apply a method (disclosed in the present disclosure) to skip some POs/PDCCH monitoring occasion(s), and the UE may detect whether some conditions are satisfied (e.g., when applying the method). If one or more conditions are satisfied, the UE may ignore/abandon/discard/release/clear the method (and/or the related configuration). In one implementation, the UE may not skip the POs/PDCCH monitoring occasion(s) when the UE ignores/abandons/discards/releases/clears the method. The UE may fallback to continue monitoring each PO/PDCCH monitoring occasion (in each DRX cycle). For example, the UE may follow the legacy PF/PO formula without considering the power saving approaches disclosed in the present disclosure. In one implementation, if one or more conditions are satisfied, the UE may perform a specific fallback mechanism/procedure. For example, the UE may perform or initiate an RA procedure, RRC connection resume procedure, RRC connection establishment procedure, RRC connection re-establishment procedure, cell (re-)selection procedure, RNA update (e.g., T380 expires or triggered upon reception of SIB1), tracking area update, and/or etc.

Assuming that a UE is indicated (from NW) to perform the PDCCH skipping disclosed in the present disclosure, and the UE applies the behavior for PDCCH skipping (e.g., skip monitoring one or more POs/PDCCH monitoring occasion(s)) based on the indicator (from NW), the condition for considering the fallback mechanism may include at least one of the following:
In one implementation, when the UE receives an indicator with the information for power saving, the UE may apply the behavior for PDCCH monitoring based on the indicator. If the UE receives a paging message (e.g., a paging message including the UE's identity), the UE may ignore/abandon/discard/release/clear the information/instruction/configuration indicated by the indicator. In one implementation, the UE may not apply the behavior for PDCCH skipping based on the indicator after that. In one implementation, the UE may continuously monitor each PO after that. For example, the UE may follow the legacy PF/PO formula without considering the power saving approaches. For example, the UE may monitor PO(s) based on legacy behavior. For example, the UE in RRC_IDLE or RRC_INACTIVE may monitor for SI change indication in its own paging occasion every DRX cycle. The UE in RRC_CONNECTED may monitor for SI change indication in any paging occasion at least once per modification period. In one implementation, the UE may perform the specific fallback mechanism/procedure mentioned in the present disclosure. In one implementation, the paging message may indicate to the UE to ignore/abandon/discard/release/clear the information/instruction/configuration indicated by the indicator. In one implementation, the paging message may not indicate to the UE to ignore/abandon/discard/release/clear the information/instruction/configuration indicated by the indicator.
In one implementation, when the UE receives an indicator with the information for power saving, the UE may apply the behavior for PDCCH monitoring based on the indicator. If the UE changes the RRC state (e.g., state transition), the UE may ignore/abandon/discard/release/clear the information/instruction/configuration indicated by the indicator. In one implementation, the UE may not apply the behavior for PDCCH skipping based on the indicator after that. In one implementation, the UE may continuously monitor each PO after that. For example, the UE may follow the legacy PF/PO formula without considering the power saving approaches. For example, the UE may monitor PO(s) based on legacy behavior (e.g., UEs in RRC_IDLE or in RRC_INACTIVE may monitor for SI change indication in its own paging occasion every DRX cycle; UEs in RRC_CONNECTED may monitor for SI change indication in any paging occasion at least once per modification period). In one implementation, the UE may perform the specific fallback mechanism/procedure disclosed in the present disclosure
   In one implementation, the RRC state change may be in response to the UE entering RRC_CONNECTED from RRC_IDLE/RRC_INACTIVE.
In one implementation, when the UE receives an indicator with an information (for power saving), the UE may apply the behavior for PDCCH monitoring based on the indicator. If the UE fails to monitor/receive/decode the paging (e.g., a DCI (e.g., paging DCI), a short message indicator, a short message, or a paging message) for a number of times and/or for a period of time, the UE may ignore/abandon/discard/release/clear the information/instruction/configuration indicated by the indicator. In one implementation, the UE may not apply the behavior for PDCCH skipping based on the indicator after that. In one implementation, the UE may continuously monitor each PDCCH monitoring occasion/PO (e.g., by following the legacy PF/PO formula without considering the power saving approach) (e.g., the UE may monitor PO(s) based on legacy behavior). For example, the UE in RRC_IDLE or RRC_INACTIVE may monitor for SI change indication in its own paging occasion every DRX cycle. The UE in RRC_CONNECTED may monitor for SI change indication in any paging occasion at least once per modification period. In one implementation, the UE may perform the specific fallback mechanism/procedure disclosed in the present disclosure.
   In one implementation, the UE may maintain a counter to count how many times it fails to monitor/receive/decode the paging on PO (e.g., a DCI (e.g., paging DCI), a short message indicator, and/or a short message). For example, if the value of the counter reaches the maximum, the UE may continuously monitor each PDCCH monitoring occasion/PO (e.g., by following the legacy PF/PO formula without considering the power saving approaches) and/or the UE may perform the specific fallback mechanism/procedure. For example, if the value of the counter reaches the maximum in a time window, the UE may continuously monitor each PDCCH monitoring occasion/PO (e.g., by following the legacy PF/PO formula without considering the power saving approaches) and/or the UE may perform the specific fallback mechanism/procedure. For example, if the value of the counter reaches zero, the UE may continuously monitor each PDCCH monitoring occasion/PO (e.g., by following the legacy PF/PO formula without considering the power saving approaches) and/or the UE may perform the specific fallback mechanism/procedure. For example, if the value of the counter reaches zero in a time window, the UE may continuously monitor each PDCCH monitoring occasion/PO (e.g., by following the legacy PF/PO formula without considering the power saving approaches) and/or the UE may perform the specific fallback mechanism/procedure. In one implementation, the UE may maintain a timer for the time window. If the timer expires and the counter does not reach the maximum value, the UE may reset the counter. The value for the timer may be configured by the NW (e.g., via system information or dedicated RRC signaling). In one implementation, if the UE performs the specific fallback mechanism/procedure, the UE may reset the counter and/or stop the timer.
   In one implementation, the UE may maintain a timer to determine whether the UE could receive any paging (e.g., a paging DCI or a short message) on a PO. The UE may (re-)start the timer when receiving the paging on the PO. However, if the timer expires (or is not running), the UE may continuously monitor each PDCCH monitoring occasion/PO (e.g., by following the legacy PF/PO formula without considering the power saving approaches) and/or the UE may perform the specific fallback mechanism/procedure.
   In one implementation, the number of times (e.g., a value for the counter) or the period of time (e.g., a value for the timer) may be configured via NAS signaling.
   In one implementation, the number of times (e.g., a value for the counter) or the period of time (e.g., a value for the timer) may be configured via an RRC configuration (e.g., RRC release message).
   In one implementation the number of times (e.g., a value for the counter) or the period of time (e.g., a value for the timer) may be configured via system information.
   In one implementation, the number of times (e.g., a value for the counter) or the period of time (e.g., a value for the timer) may be carried in a short message and/or a paging message.
In one implementation, when the UE receives an indicator with the information for power saving, the UE may apply the behavior for PDCCH monitoring based on the indicator. If the UE changes the cell (e.g., camps on another cell after cell (re)selection, handover to another cell), the UE may abandon/discard/release/clear the information/instruction/configuration indicated by the indicator. In one implementation, the UE may not apply the behavior for PDCCH skipping based on the indicator after that. In one implementation, the UE may continuously monitor each PDCCH monitoring occasion/PO after that. For example, the UE may follow the legacy PF/PO formula without considering the power saving approaches. For example, the UE may monitor PO(s) based on legacy behavior. For example, the UE in RRC_IDLE or RRC_INACTIVE may monitor for SI change indication in its own paging occasion every DRX cycle. The UE in RRC_CONNECTED may monitor for SI change indication in any paging occasion at least once per modification period. In one implementation, the UE may perform the specific fallback mechanism/procedure disclosed in the present disclosure.
In one implementation, when the UE receives an indicator with the information for power saving, the UE may apply the behavior for PDCCH monitoring based on the indicator. If the UE performs a specific procedure disclosed below, the UE may ignore/abandon/discard/release/clear the information/instruction/configuration indicated by the indicator. In one implementation, the UE may not apply the behavior for PDCCH skipping based on the indicator after that. In one implementation, the UE may continuously monitor each PDCCH monitoring occasion/PO after that. For example, the UE may follow the legacy PF/PO formula without considering the power saving approaches. For example, the UE may monitor PO(s) based on legacy behavior. For example, the UE in RRC_IDLE or RRC_INACTIVE may monitor for SI change indication in its own paging occasion every DRX cycle. The UE in RRC_CONNECTED may monitor for SI change indication in any paging occasion at least once per modification period.
   In one implementation, the specific procedure may be a UL transmission (e.g., small data transmission).
   In one implementation, the specific procedure may be an RA procedure.
   In one implementation, the specific procedure may be RRC connection establishment, RRC connection re-establishment, RRC connection resume procedure, cell (re)selection, RNA update (e.g., T380 expires or triggered upon reception of SIB1), tracking area update, etc.
In one implementation, when the UE receives an indicator with the information for power saving, the UE may apply the behavior for PDCCH monitoring based on the indicator. If the channel quality is higher/lower than a threshold, the UE may ignore/abandon/discard/release/clear the information/instruction/configuration indicated by the indicator. In one implementation, the UE may not apply the behavior for PDCCH skipping based on the indicator after that. In one implementation, the UE may continuously monitor each PDCCH monitoring occasion/PO after that. For example, the UE may follow the legacy PF/PO formula without considering the power saving approaches. For example, the UE may monitor PO(s) based on legacy behavior. For example, the UE in RRC_IDLE or RRC_INACTIVE may monitor for SI change indication in its own paging occasion every DRX cycle. The UE in RRC_CONNECTED may monitor for SI change indication in any paging occasion at least once per modification period. In one implementation, the UE may perform the specific fallback mechanism/procedure disclosed in the present disclosure.
   In one implementation, the UE may perform measurement on DL reference signal(s) (e.g., SSB/CSI-RS) to determine the DL channel quality (e.g., based on the measurement results of RSRP, RSRQ, RSSI, SINR, etc.) In one implementation, the DL channel quality may be measured based on the criteria of cell (re-)selection.
   In one implementation, the UE may be configured with the threshold(s) by the NW via dedicated signaling (e.g., in the suspend configuration of RRCRelease message). In one implementation, the UE may be configured with the threshold(s) by the NW via broadcast system information (e.g., SIB1, other SI, small data specific system information). In one implementation, the UE may be preconfigured with the threshold(s) by the NW.

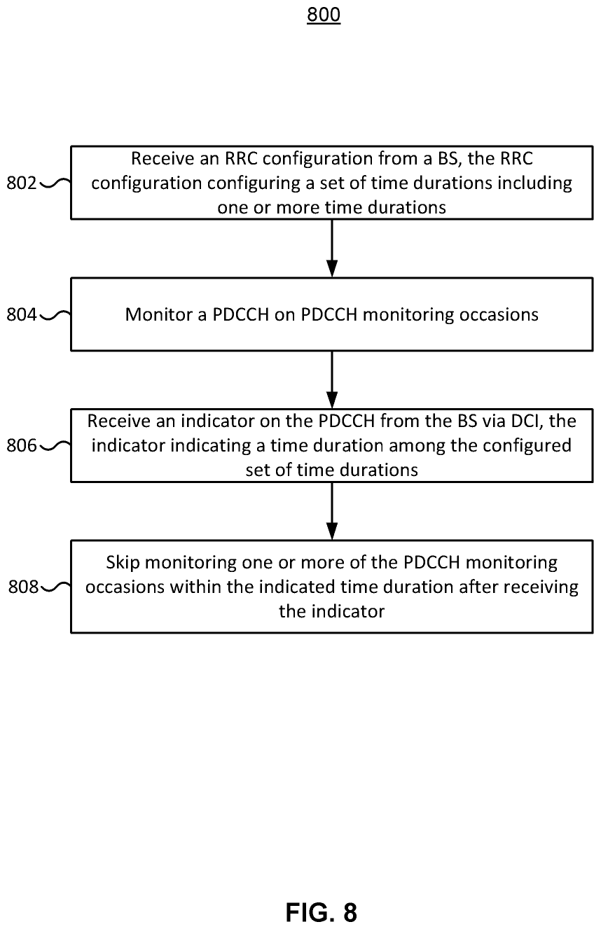

FIG. 8 illustrates a method 800 performed by a UE for a power saving operation according to an example implementation of the present disclosure. In action 802, the UE receives an RRC configuration from a B S, the RRC configuration configuring a set of time durations including one or more time durations. For example, the configured set of time durations may include {1 slot, 2 slots, 4 slots, 8 slots}. For example, the configured set of time durations may include {1 PO, 2 POs, 4 POs, 8 POs}. For example, the configured set of time durations may include {1 DRX cycle, 2 DRX cycles}. For example, the configured set of time durations may include a single entry, such as {8 slots}.

In action 804, the UE monitors a PDCCH on PDCCH monitoring occasions. The PDCCH monitoring occasions may be determined according to a search space configured by the BS. The search space may be configured by PDCCH-config. The search space may be a paging search space.

In action 806, the UE receives an indicator on the PDCCH from the BS via DCI, the indicator indicating a time duration among the configured set of time durations. For example, the indicator indicates {1 slot} among the configured set of time durations. For example, the indicator indicates {2 POs} among the configured set of time durations. In one implementation, the DCI may be a scheduling DCI, e.g., DCI format 1_1, 0_1, 1_2, and/or 0_2. In one implementation, the DCI may be a DCI format 1_0 (e.g., paging DCI). In one implementation, the DCI may be scrambled by (or addressed to) a C-RNTI, CS-RNTI, and/or P-RNTI.

In action 808, the UE skips monitoring one or more of the PDCCH monitoring occasions within the indicated time duration (e.g., 1 slot or 2POs) after receiving the indicator.

In one implementation, the UE may monitor the PDCCH on the PDCCH monitoring occasions after the indicated time duration is over. For example, the UE may skip PDCCH monitoring during the indicated time duration and then perform PDCCH monitoring after the indicated time duration is over. Example implementations may be as referred to in FIG. 5, FIG. 6, and FIG. 7.

In one implementation, the time duration is one of a number of PDCCH monitoring occasions, a number of time units, a number of POs, and a number of DRX cycles. The BS may configure the time duration as X PDCCH monitoring occasions, X time units, X POs, or X DRX cycles, where X may be a positive real number or a sequence of positive real numbers. The time unit may be one of a slot, a symbol, a hyper system frame, a system frame, a radio frame, a second, and a millisecond.

In one implementation, the time duration may be determined based on a timer configured by the RRC configuration. The UE may start or restart the timer upon receiving the indicator via the DCI. The UE may skip PDCCH monitoring while the timer is running, and the UE may perform PDCCH monitoring after the timer stops or expires.

In one implementation, the DCI in action 806 may further indicate a UE group. For example, the DCI may include/indicate a UE group ID. The DCI may be a UE group-specific signaling. The UE group may be formed based on at least one of a UE ID and UE assistance information. The UE assistance information may be provided by the UE to the BS. The UE may determine whether to skip monitoring the PDCCH monitoring occasions according to whether the UE is associated with the UE group indicated by the UE group ID. For example, the UE may be aware of whether the information (e.g., information for power saving, UE group ID) in the DCI (e.g., paging DCI) is for the UE (or the UE group to which the UE belongs) based on the UE group ID.

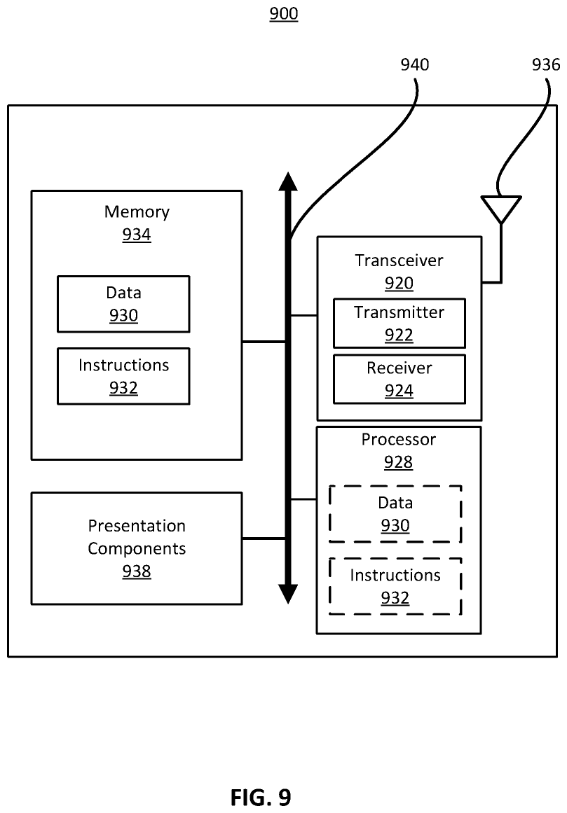

FIG. 9 is a block diagram illustrating a node 900 for wireless communication according to an example implementation of the present disclosure. As illustrated in FIG. 9, the node 900 may include a transceiver 920, a processor 928, a memory 934, one or more presentation components 938, and at least one antenna 936. The node 900 may also include a radio frequency (RF) spectrum band module, a BS communications module, a network communications module, and a system communications management module, Input/Output (I/O) ports, I/O components, and a power supply (not illustrated in FIG. 9).

Each of the components may directly or indirectly communicate with each other over one or more buses 940. The node 900 may be a UE or a BS that performs various functions disclosed with reference to FIGS. 1 through 8.

The transceiver 920 has a transmitter 922 (e.g., transmitting/transmission circuitry) and a receiver 924 (e.g., receiving/reception circuitry) and may be configured to transmit and/or receive time and/or frequency resource partitioning information. The transceiver 920 may be configured to transmit in different types of subframes and slots including but not limited to usable, non-usable, and flexibly usable subframes and slot formats. The transceiver 920 may be configured to receive data and control channels.

The node 900 may include a variety of computer-readable media. Computer-readable media may be any available media that may be accessed by the node 900 and include both volatile and non-volatile media, and removable and non-removable media.

The computer-readable media may include computer storage media and communication media. Computer storage media may include both volatile and non-volatile media, and removable and non-removable media implemented in any method or technology for storage of information such as computer-readable instructions, data structures, program modules, or data.

Computer storage media may include RAM, ROM, EPROM, EEPROM, flash memory or other memory technology, CD-ROM, Digital Versatile Disks (DVD) or other optical disk storage, magnetic cassettes, magnetic tape, magnetic disk storage, or other magnetic storage devices. Computer storage media may not include a propagated data signal. Communication media may typically embody computer-readable instructions, data structures, program modules, or other data in a modulated data signal, such as a carrier wave, or other transport mechanism and include any information delivery media.

The term “modulated data signal” means a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 934 may include computer-storage media in the form of volatile and/or non-volatile memory. The memory 934 may be removable, non-removable, or a combination thereof. Example memory may include solid-state memory, hard drives, optical-disc drives, etc. As illustrated in FIG. 9, the memory 934 may store computer-readable, computer-executable instructions 932 (e.g., software codes) that are configured to cause the processor 928 to perform various functions disclosed herein, for example, with reference to FIGS. 1 through 8. Alternatively, the instructions 932 may not be directly executable by the processor 928 but may be configured to cause the node 900 (e.g., when compiled and executed) to perform various functions disclosed herein.

The processor 928 (e.g., having processing circuitry) may include an intelligent hardware device, e.g., a Central Processing Unit (CPU), a microcontroller, an ASIC, etc. The processor 928 may include memory. The processor 928 may process the data 930 and the instructions 932 received from the memory 934, and information transmitted and received via the transceiver 920, the baseband communications module, and/or the network communications module. The processor 928 may also process information to be sent to the transceiver 920 for transmission via the antenna 936 to the network communications module for transmission to a core network.

One or more presentation components 938 may present data indications to a person or another device. Examples of presentation components 938 may include a display device, a speaker, a printing component, and a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed, and many rearrangements, modifications, and substitutions are possible without departing from the scope of the present disclosure.

1. A method performed by a user equipment (UE) for a power saving operation, the method comprising:
receiving a radio resource control (RRC) configuration from a base station (BS), the RRC configuration configuring a set of one or more time durations;
beginning monitoring a physical downlink control channel (PDCCH) on a plurality of PDCCH monitoring occasions;
receiving an indicator on the PDCCH from the BS via downlink control information (DCI), the indicator indicating a first time duration among the set of one or more time durations; and
skipping monitoring the PDCCH on one or more of the plurality of PDCCH monitoring occasions within the first time duration after receiving the indicator.

2. The method of claim 1, further comprising:
resuming monitoring the PDCCH on the plurality of PDCCH monitoring occasions after the first time duration is over.

3. The method of claim 1, wherein the first time duration is one of a number of the plurality of PDCCH monitoring occasions, a number of time units, a number of paging occasions (POs), or a number of discontinuous reception (DRX) cycles.

4. The method of claim 3, wherein the time units comprise one of slots, symbols, hyper system frames, system frames, radio frames, seconds, or milliseconds.

5. The method of claim 1, wherein the first time duration is determined based on a timer configured by the RRC configuration.

6. The method of claim 1, wherein the plurality of PDCCH monitoring occasions are determined according to a search space configured by the BS.

7. The method of claim 1, wherein the DCI comprises a DCI format 1_0.

8. The method of claim 1, wherein the DCI further indicates a UE group.

9. The method of claim 8, wherein the UE group is formed based on at least one of a UE identifier (ID) or UE assistance information.

10. The method of claim 8,
wherein the UE belongs to the UE group.

11. A user equipment (UE) for performing a power saving operation, the UE comprising:
at least one processor; and
at least one memory coupled to the at least one processor, the at least one memory storing one or more computer-executable instructions that, when executed by the at least one processor, cause the UE to perform operations comprising:
receiving a radio resource control (RRC) configuration from a base station (BS), the RRC configuration configuring a set of one or more time durations;
beginning monitoring a physical downlink control channel (PDCCH) on a plurality of PDCCH monitoring occasions;
receiving an indicator on the PDCCH from the BS via downlink control information (DCI), the indicator indicating a first time duration among the set of one or more time durations; and
skipping monitoring the PDCCH on one or more of the plurality of PDCCH monitoring occasions within the first time duration after receiving the indicator.

12. The UE of claim 11, the operations further comprising:
resuming monitoring the PDCCH on the plurality of PDCCH monitoring occasions after the first time duration is over.

13. The UE of claim 11, wherein the first time duration is one of a number of the plurality of PDCCH monitoring occasions, a number of time units, a number of paging occasions (POs), or a number of discontinuous reception (DRX) cycles.

14. The UE of claim 13, wherein the time units comprise one of slots, symbols, hyper system frames, system frames, radio frames, seconds, or milliseconds.

15. The UE of claim 11, wherein the first time duration is determined based on a timer configured by the RRC configuration.

16. The UE of claim 11, wherein the plurality of PDCCH monitoring occasions are determined according to a search space configured by the BS.

17. The UE of claim 11, wherein the DCI comprises a DCI format 1_0.

18. The UE of claim 11, wherein the DCI further indicates a UE group.

19. The UE of claim 18, wherein the UE group is formed based on at least one of a UE identifier (ID) or UE assistance information.

20. The UE of claim 18, wherein the UE belongs to the UE group.
